(19) United States
(12) Patent Application Publication
(10) Pub. No.: US 2013/0342165 A1
(43) Pub. Date: Dec. 26, 2013

(54) Networked Universal Electric Vehicle Charging System

(71) Applicant: Bruce Brimacombe, Mesa, AZ (US)

(72) Inventor: Bruce Brimacombe, Mesa, AZ (US)

(21) Appl. No.: 13/923,329

(22) Filed: Jun. 20, 2013

Related U.S. Application Data
(60) Provisional application No. 61/661,808, filed on Jun. 20, 2012.

(51) Int. Cl. B60L 11/18

(52) U.S. Cl. CPC B60L 11/1824
USPC 320/109

(57) ABSTRACT

An electric vehicle charging station system has numerous charging nodes, each charging node including a charging station having at least two connector interfaces selected from the group consisting of a Level 1 charging device, a Level 2 charging device, a Tesla charging device, and a Level 3/Fast DC charging device, wherein the plurality of charging nodes are in communication with each other through a network. The charging station has a display device on each charging station with one or more portals for a web-based or consumer-focused content, wherein content is provided by a vendor concentrically located within a predetermined distance to the system, and other content provides the location of other charging nodes. A selection device allows the consumer to select a particular portal, wherein the selection device transmits the selected content to a mobile device associated with the consumer.

### RELATED APPLICATION

This application claims the benefit of pending provisional patent application No. 61/661,808, filed Jun. 20, 2012.

### TECHNICAL FIELD

The inventions described herein are directed to networked electric vehicle (EV) charging nodes and charging stations having at least two different types of charging connectors and the ability for a consumer to receive web-based or consumer-focused information.

### BACKGROUND

Electric vehicles (EV), much like the conventional internal combustion engine powered vehicles, have a finite range. EVs are three to five times more efficient as internal combustion vehicles, cost less to drive and maintain, and offer zero air pollution. In spite of these advantages, the market penetration of EVs is hindered by the limited number of charging options available outside the urban city regions. There are numerous petroleum refueling spots along interstates, state highways and large secondary roads allowing people to travel between cities and states using conventional vehicles. However, there are very few EV charge stations on the highway and freeway systems, and currently there is no network allowing EV drivers to travel coast to coast or even between states. For this technology to succeed, a large scale charging network is vital. Further, conventional economics stifle the progress of such a network inception, and a new multi-facet solution is needed.

### SUMMARY

In one embodiment there is disclosed an electric vehicle charging station system comprising a) a plurality of charging nodes, each charging node including a charging station having at least two electric vehicle supply equipment selected from the group consisting of a Level 1 charging device, a Level 2 charging device, a Tesla charging device, and a Level 3/Fast DC charging device, wherein the plurality of charging nodes are in communication with each other through a network; b) a display device disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle; and c) a selection device that allows the consumer to select a particular portal, wherein the selection device transmits the selected content to a mobile device associated with the consumer.

### BRIEF DESCRIPTION OF THE DRAWINGS

FIG. 1 is an overview that shows a map and a schematic of a charging station.

FIG. 2 shows a “GOe3 Universal Quick Charging Station” system 50 that forms a part of each node 12, 14, 16, etc.

FIG. 3 shows a schematic of the charging station displaying web- or consumer-centric content.

### DETAILED DESCRIPTION OF EMBODIMENTS

For EV technology to succeed, a large-scale charging network is vital. Further conventional economics stifle the progress of such a networks inception, and a new multi-facet solution is needed. Even for EVs having a large mileage capability, such as the Tesla Roadster that has a 240-mile range on a signal charge, it became evident that even with such a great range, they are still bound to urban travel only. We realized that if EVs are going to become a fully functional part of American life, there needs to be a coast-to-coast charging network. After analyzing the financials, we saw that EV chargers were not viable in a classical model, and the integration of web services and content was vital to balance the initial cost of the system. As used herein, “EV” includes all types of vehicles that use electrical energy to provide locomotion, including, but not limited to, all-electric vehicles and hybrid vehicles. The system allows the consumer to view regional information, amongst other web-content, and choose to have select information sent to their mobile device.

Currently, there are three types of charging connectors used to recharge the batteries of EVs. These include Level 1, Level 2 and Level 3/Direct-current (DC) Fast charging:
a) Level 1 provides charging through a 120 volt (V) AC plug and requires electrical installation per the National Electrical Code. Most, if not all, EVs will come with a Level 1 cord set so that no additional charging equipment is required. On one end of the cord is a standard, three-prong household plug (NEMA 5-15 connector). On the other end is a J1772 standard connector, which plugs into the vehicle. Level 1 is typically used for charging when there is only a 120 V outlet available. Based on the battery type and vehicle, Level 1 charging adds about 2 to 5 miles of range to an EV per hour of charging time.
b) Level 2 equipment offers charging through 240 V (typical in residential applications) or 208 V (typical in commercial applications) electrical service. Level 2 charging requires installation of home charging or public charging equipment and a dedicated circuit of 20 to 80 amps, depending on the EV requirements. This charging option can operate at up to 80 amperes and 19.2 kW. However, most residential Level 2 charging equipment will operate at lower power. Many such units operate at up to 30 amperes, delivering 7.2 kW of power. These units require a dedicated 40 amp circuit. Most homes have 240 V service available. Because Level 2 charging equipment can easily charge a typical EV battery overnight, this will be a common installation for homes. Level 2 equipment also uses the same connector on the vehicle as Level 1 equipment. Based on the battery type and circuit capacity, Level 2 adds about 10 to 20 miles of range per hour of charging time, depending on the vehicle.
c) Level 3, also known as Direct-Current (DC) Fast Charging equipment (480 V AC or 208 VAC three phase input) enables rapid charging along heavy traffic corridors and at public stations. A DC fast charge can add 60 to 80 miles of range to a light-duty EV in about 20 minutes.
   Inductive charging equipment, which uses an electromagnetic field to transfer electricity to a EV without a cord, is still being used in certain areas where it was installed for EVs in the 1990s. Currently available plug-in vehicles do not use inductive charging, but SAE International is working on a standard that may apply in the future. See http://www.afdc.energy.gov.

Most modern charging equipment and EVs have a standard connector and receptacle based on the SAE J1772 standard developed by SAE International. Any vehicle with this plug receptacle should be able to use any J1772-compliant Level 1 or Level 2 charging equipment. All major vehicle and charging system manufacturers support this standard in the U.S., which should eliminate drivers' concerns about whether their vehicles are compatible with the infrastructure. Some currently available plug-in vehicles that are equipped to accept DC fast charging are using the CHAdeMO connector. SAE International is also working on a “hybrid connector” standard for fast charging that adds high-voltage DC power contact pins to the J1772 connector, enabling use of the same receptacle for all levels of charging. See http:www.afdc.energy.gov. Tesla Motors refers to its plug as “The Universal Mobile Connector” plug or port.

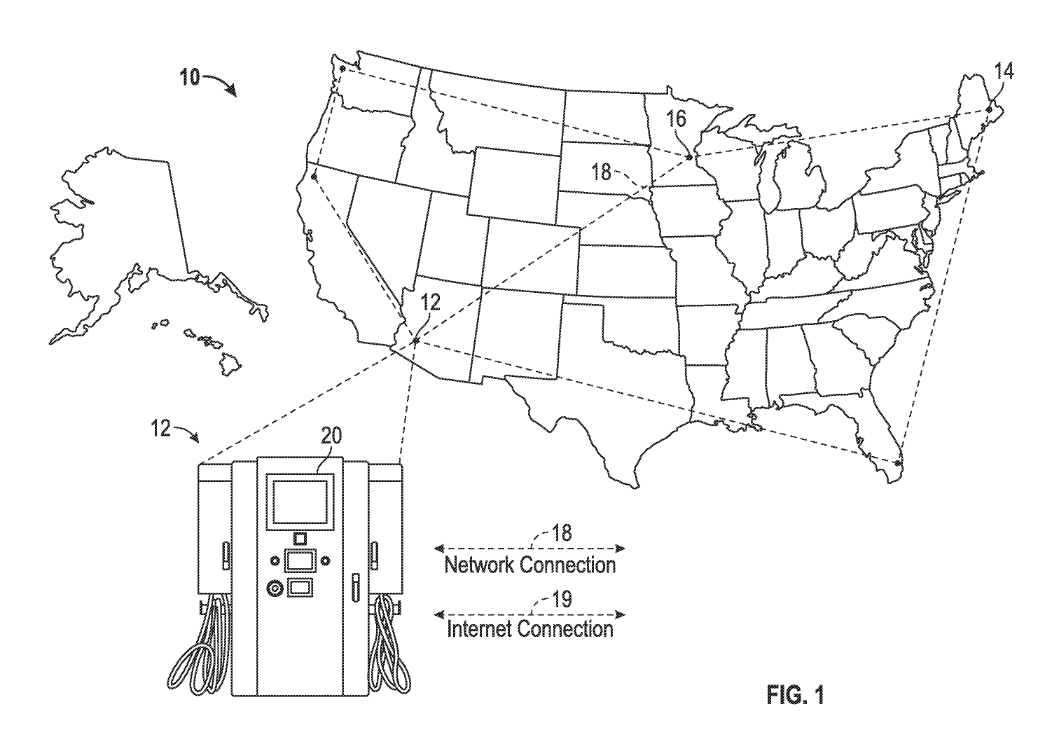

In one embodiment as shown in FIG. 1, a universal charging node/system 10 includes many individual charging nodes 12, 14, 16, etc. spanning across more than one state linking together EV vehicle charging stations and forming a coast to coast network across the United States. Each node includes at least one Level 3 and/or Level 2 charging station(s). Each node also includes a display device 20 connected to the internet and is capable of interchanging web-based content and information. Each node 12, 14, 16, etc. communicates through a wired, WiFi, or cell phone communication system 18 and to the internet 19 as an integral part of the network. Nodes receive and report all activity experienced during operation.

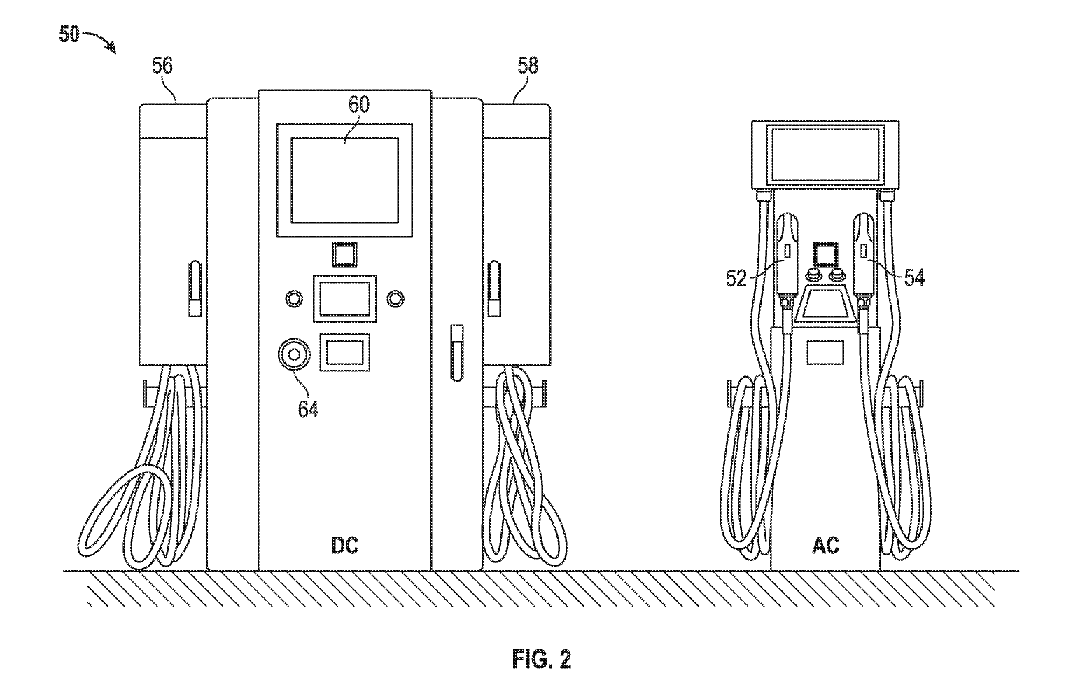

FIG. 2 shows a “GOe3 Universal Quick Charging Station” system 50 that forms a part of each node 12, 14, 16, etc. These may be catalog numbers “u” universal “s” stand alone, or “E3” for full level 3/2 universal and E2 for Level 2 charging station. In this embodiment, at least two or more connector interfaces are included to allow power delivery to EV with any one or more matching plug type. In one embodiment, the charging station includes a J-1772A or J1772E connector 52, a Tesla connector 54, a CHAdeMO connector 56, and a J-1772E combo connector 58. The J-1772E combo is not a standard yet and does not have an official designation. It has been referred to as J-1772 Combo or J-1772 DC. The connector location depicted by the drawing is for illustration only and does not solidify a design specification, i.e. the plug type and side location may be changed as needed. Currently, a J-1772E connector 58 is a planned future install to the system 50 when it becomes a standard. The quick-charging station system 50 has the ability to deliver both Level 3 DC to DC quick charge and Level 2 AC to DC (up to 70 Amps delivery). The quick charging station system 50 can charge at least two EV's simultaneously.

In another embodiment, the quick-charging station system 50 includes a touch screen device 60 that allows the consumer/user to receive, send, and interact with web delivered media and content. The touch screen device 60 preferably includes a 15-inch (diagonal) or larger touch screen 62. An interface is interconnected with the GOe3 quick charging station system 50 using Webportal, Small Business Portal, mobile app services and the like. The quick-charging station system 50 further includes a “GimmE” button 64 that allows a consumer/user to select an item displayed on the touch screen 62. The GimmE button 64 is an activator that causes selected web content to be sent to a GOe3 mobile application on the consumer's/user's/patron's phone. The button 64 may be a physical or screen represented button.

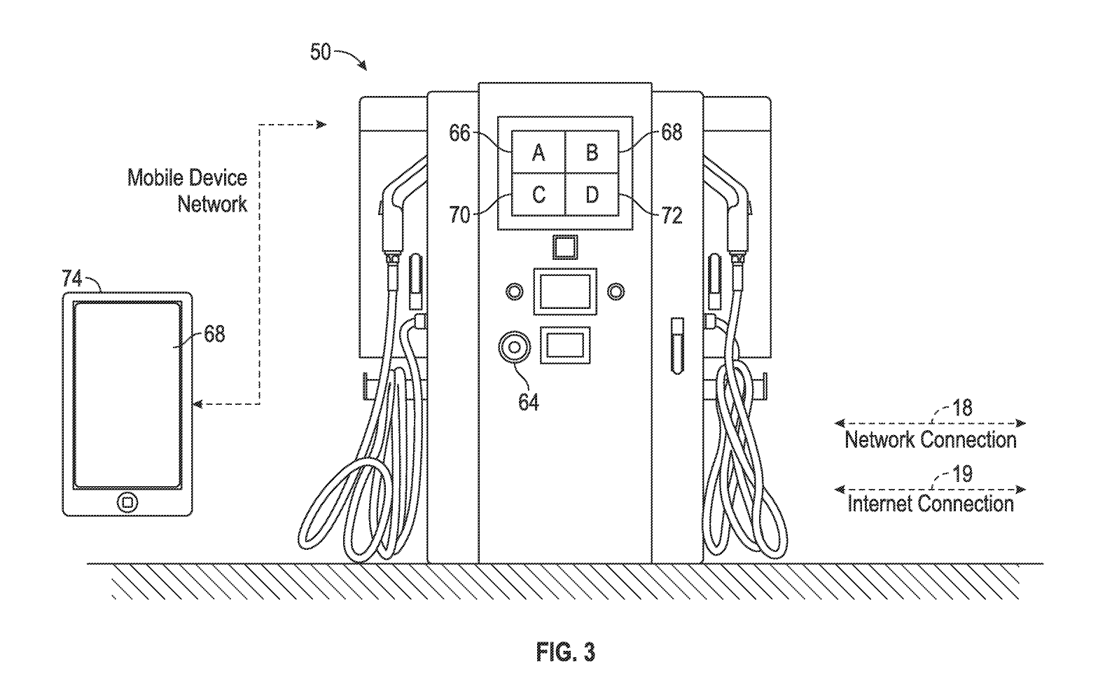

In another embodiment, web-based or consumer-focused content was displayed on the touch screen 62 using multiple portals 66, 68, 70 and 72, as shown in FIG. 3. This was designed to accommodate many web feeds, email, ads, entertainment, web commerce, social media, and any other type of consumer-focused content (represented as “A”, “B”, “C” and “D” on FIG. 3 to be simultaneously displayed to the consumer/user. One type of consumer-focused content that may be displayed on one of the portals is the location and distance to adjacent charging nodes. When the consumer/user sees an ad or other web content that interests them, they would push the “GimmE” button 64 causing a copy of the web content to be sent to their mobile device 74. The mobile device includes but is not limited to a smart phone, tablet, laptop and the like. A mobile application that is compatible with the GOe3 interface is installed on the mobile device that is linked to the customer's ID number, allowing for routing of the selected web content to the mobile device.

A type of interface that can be used with the quick-charging station system 50 is a small business portal (SBP). The SBP is a service that allows businesses selling goods or services to advertise through the GOe3 E3/E2 quick-charging station system 50. A key differentiator of the SBP is that the marketing information provided by the small business is concentric to the charging station 50 up to a set distance. In one embodiment, a restaurant located approximately 10 miles from a charging station 50 would be displayed, but a different restaurant located 25 miles, 50 miles and like would not be displayed on that charging station 50. This allows the customer to receive advertising that is regional to a particular charging station 50. The web content that is displayed may be defined as being within a predetermined distance to the business being served. The concentric mile ranges are up to about 35 miles. As the chargers are going to be placed every 50 to 70+/−10 miles. Concentric advertising offers advertisers a lower price point and greater effectiveness in targeting. While charging the EV, the customer is exposed to one or more ads for goods and services regional to that charging station 50.

The businesses and points of interest at present are limited by their ability to pay. Currently a bed and breakfast pays 10's of thousands to be on hotels.com. This system will offer a more affordable option. Greater accuracy of targeting is available for local business because advertising is regional to each charger station. The current options miss local companies that cannot afford to pay, or do not pay because they are not that kind of company. Yelp, Google, MapQuest often miss the less connected items in smaller towns. Beyond that the system is intended to display Local news, Chat rooms, Blogs, Postings, Videos (like someone doing an ice sculpture in the town square, they can post it for visitors to know), web store both for local stores to the charger and internet wide. We have our own version of an auction system (local and internet wide). Coupons are local to the charger. In another embodiment there is featured the ability to set reservations. In another embodiment, there are exclusive travel discounts available only through the SBP from companies local to the charger. Events and regional calendars that are also local to the charger. In another embodiment the SBP access will also be given to educational and non-profit groups, including, but not limited to, students, startups and others doing good for the community.

The GimmE button is part of the E3 branding. Whether it is the physical version or the on-screen software, it will look the same. Color may vary due to material or intent. One example is when the on-screen GimmE button is red instead of green. The red color would signify a non-selectable item. The GimmE functions as a selector, but also adds branding and is intended to add a “fun factor” into the selection.

The SBP software is developed inhouse, with access is sold or given to small business, persons, groups.

Our portal allows users access to other portals without leaving our portal. The GimmE feature is only available through our own portal. For example: Facebook is a closed system with heavy limits on access to outside systems, because of concerns about the privacy of personal information. The system is an open “pipe” allowing outside features/services access. All likes and preferences are tagged to the customer's GOe3 charging fab and not their personal information. For example, our system tracks that the holder of key fab number 00303xxx likes pizza and Barbie museums. If the town in which she is charging has both, the patron sees ads for both while charging. What our system will not know is that “Todd Tuffguy” likes pizza and Barbie museums, nor will anyone else. Our system offers a high level of privacy and security.

In one embodiment the display is quartered, allowing for four points of content. If a digital version of the GimmE button is present, it will either be at the center of the four screens or along the right or left border. This preference may be user configurable.

Both options of free and purchased content are there. The patron has the option of using a personal account linked key fab like a credit card.

On the face of the charging station between the video screen and the side, there is another smaller screen (preferably about 5.7 inch), this is a PLC (programmable logic controller) added by the manufacturer to control which chargers being used.

Those of ordinary skill in the art will appreciate that the foregoing description is illustrative of the invention. The disclosure is not intended to be limited to the specific embodiments described above. The details of the materials used, the uses described, and the arrangement and type of mechanical objects of the invention can be altered without materially changing the scope of the instant invention. It is to be understood that the above description has been made in an illustrative fashion, and not a restrictive one. Combinations of the above embodiments, and other embodiments not specifically described herein will be apparent to those of skill in the art. The scope of the various embodiments of the invention includes any other applications in which the extension device is used. Therefore the scope of the inventive concept, including all of its embodiments and appended claims, along with a full range of equivalents should be considered to be the full inventive concept.

The organization of the foregoing examples and description should not be construed to be the only features of the invention, nor should the examples be limiting to the inventive concept. The claims appended to this disclosure reflect subsets of the instant invention. The appended claims, and all claims which may be later added are hereby incorporated into the description of the embodiments of the invention, with each claim standing on its own as a separate preferred embodiment.

What is claimed is:

1. An electric vehicle charging station system comprising:
a. A plurality of charging nodes, each charging node including a charging station capable of charging at least two electric vehicle and having at least two connector interfaces selected from the group consisting of a Level 1 charging device, a Level 2 charging device, a Tesla charging device, and a Level 3/Fast DC charging device, wherein the plurality of charging nodes are in communication with each other through a network;
b. A display device disposed on each charging station, the display device having one or more portals that display a web-based or consumer-focused content, wherein a portion of the content is provided by a vendor that provides a good or service concentrically located within a predetermined distance to the system, and another portion of the content provides the location of adjacent charging nodes to a consumer using the system to charge an electric vehicle; and
c. A selection device that allows the consumer to select a particular portal, wherein the selection device transmits the selected content to a mobile device associated with the consumer.
